(19) United States
(12) Patent Application Publication
(10) Pub. No.: US 2008/0237403 A1
(43) Pub. Date: Oct. 2, 2008

(54) METAL INJECTION MOLDING PROCESS FOR BIMETALLIC APPLICATIONS AND AIRFOIL

(75) Inventors: Thomas Joseph Kelly, Cincinnati, OH (US); Mark Kevin Meyer, Centerville, OH (US); Melissa Jane Parks, Loveland, OH (US); Stephen Joseph Ferrigno, Cincinnati, OH (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: GENERAL ELECTRIC COMPANY, Schenectady, NY (US)

(21) Appl. No.: 11/691,032

(22) Filed: Mar. 26, 2007

(51) Int. Cl. B64C 3/14; B22F 7/00

(52) U.S. Cl. 244/34 A; 419/6

(57) ABSTRACT

A method of producing an airfoil including the steps of providing a first preform having a metallic powder of a first alloy, the first preform defining an airfoil body having curved pressure and suction sides. A tip cap is disposed between the pressure and suction sides of the airfoil at a radially outer end of the airfoil body. A partial height squealer tip extends radially outwards from the tip cap to provide a second preform that is a metallic powder of a second alloy different from the first alloy. The tip cap is formed in the shape of an extension of the squealer tip. The first and second preforms are sintered to consolidate the metal powders. An airfoil according to the method is also disclosed.

### BACKGROUND OF THE INVENTION

This invention relates generally to high-temperature components for gas turbine engines and more particularly to components having a composition of more than one alloy.

Current techniques for producing bimetallic components entails the use of joining processes such as tungsten inert gas welding, electron beam welding, inertia welding, brazing and similar processes. These methods are expensive, can leave weakened heat affected zones and are often difficult to inspect.

Thermal and mechanical loads applied to components such as leading and trailing edges and tips of a gas turbine engine airfoil can adversely affect the airfoil's useful life. Airfoils in gas turbine engines experience durability problems at the tip of the airfoil in the form of cracking due to thermally-induced stress and material loss due to oxidation and rubbing. This can be addressed by using an alloy having increased resistance to environmental oxidation and corrosion. However, it is undesirable to upgrade the entire airfoil to a more thermal-resistant and oxidation resistant alloy because this increases component cost and perhaps weight.

Materials having better high temperature properties than conventional superalloys are available. However, their increased density and cost relative to conventional superalloys discourages their use for the manufacture of complete gas turbine components, so they are typically used as coatings or as small portions of components. These highly environmentally resistant materials have proven difficult to attach to the basic airfoil alloys.

Accordingly, there is a need for a method of producing bimetallic components.

There is also a need for a method of attaching environmentally resistant alloys to conventional superalloys.

### BRIEF SUMMARY OF THE INVENTION

The above-mentioned need is met by the present invention, which according to one aspect provides a method of producing a bimetallic component, including providing a first preform formed of a metallic powder of a first alloy. A second preform includes a metallic powder of a second alloy different from the first alloy. The first and second preforms are heated to sinter the metal powders together into a consolidated metallic component.

According to another aspect of the invention, a method is provided for producing an airfoil that includes providing a first preform having a metallic powder of a first alloy. The first preform includes an airfoil body having curved pressure and suction sides, a tip cap disposed between the pressure and suction sides at a radially outer end of the airfoil body, and a partial height squealer tip extending radially outwards from the tip cap. A second preform is provided having a metallic powder of a second alloy different from the first alloy formed in the shape of an extension of the squealer tip. The first and second preforms are heated to sinter the metal powders together in a consolidated airfoil.

According to another aspect of the invention, the first preform is fabricated by providing a first mixture of a metallic powder of a first alloy and a binder, melting the binder and extruding the first mixture in a mold to form a first preform, and leaching the first preform to remove excess binder. The second preform is fabricated by providing a first mixture of a metallic powder of a second alloy and a binder, melting the binder and extruding the second mixture in a mold to form a second preform, and leaching the first preform to remove excess binder.

According to another aspect of the invention, an airfoil is provided, having an airfoil body with curved pressure and suction sides, a tip cap disposed between the pressure and suction sides at a radially outer end of the airfoil body and a partial height squealer tip extending radially outwards from the tip cap and formed of a first preform comprising a metallic powder of a first alloy. The airfoil also includes an extension of the squealer tip formed of a metallic powder of a second alloy different from the first alloy. The first and second preforms are sintered to consolidate the metal powders.

### BRIEF DESCRIPTION OF THE DRAWINGS

The invention may be best understood by reference to the following description taken in conjunction with the accompanying drawing figures in which:

FIG. 1 is a perspective view of an exemplary turbine blade;

FIG. 2 is a cross-sectional view of a portion of the turbine blade of FIG. 1, showing a squealer tip thereof;

FIG. 3 is a schematic side view of an injection molding apparatus; and

FIG. 4 is a schematic side view of a preform being removed from the mold show in FIG. 3; and

FIG. 5 is a flow diagram of a method of uniting metallic components as described in this application.

### DETAILED DESCRIPTION OF THE INVENTION

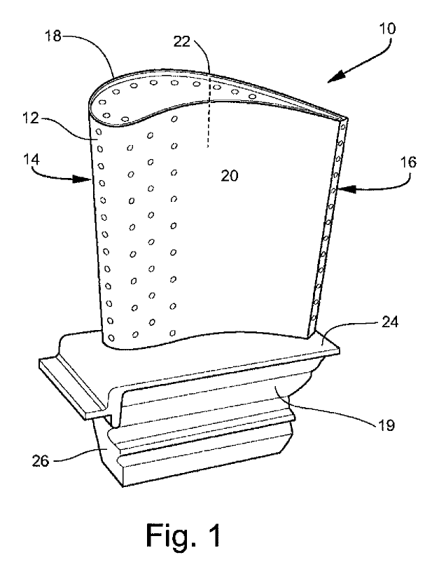

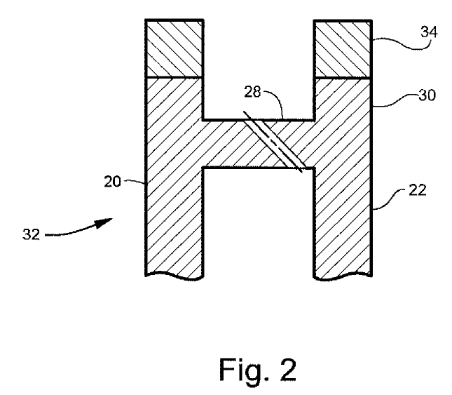

Referring to the drawings wherein identical reference numerals denote the same elements throughout the various views, FIGS. 1 and 2 depict an exemplary turbine blade 10 for a gas turbine engine. The present invention is equally applicable to the construction of other types of metallic components, such as stationary turbine vanes, frames, combustors, and the like. The turbine blade 10 includes an airfoil 12 having a leading edge 14, a trailing edge 16, a tip 18, a root 19, a concave pressure sidewall 20, a convex suction sidewall 22, a platform 24, and dovetail 26.

In accordance with the method of the present invention, the turbine blade 10 is constructed from first and second preforms 32 and 34. For example, the first preform 32 may include the pressure and suction sidewalls 22 and 24, a tip cap 28, and an integrally-formed partial height squealer tip 30. The first preform 32 typically comprises a known type of a nickel or cobalt-based superalloy having high-temperature strength properties suitable for the intended operating conditions. Examples of known materials for constructing the first preform 32 include RENE 77, RENE 80, RENE 142, and RENE N4 and N5 nickel-based alloys.

The second preform 34 includes a squealer tip extension adjacent the partial height squealer tip 30. The squealer tip extension preferably includes an alloy that exhibits superior high-temperature oxidation resistance compared to the base alloy of the first preform 32.

One example of a suitable material for this purpose is a rhodium-based alloy having from about three atomic percent to about nine atomic percent of at least one precipitation-strengthening metal selected from the group that includes zirconium, niobium, tantalum, titanium, hafnium, and mixtures thereof; up to about four atomic percent of at least one solution-strengthening metal selected from the group consisting of molybdenum, tungsten, rhenium, and mixtures thereof; from about one atomic percent to about five atomic percent ruthenium; up to about ten atomic percent platinum; up to about ten atomic percent palladium; and the balance rhodium; the alloy further comprising a face-centered-cubic phase and an L1₂-structured phase.

Another suitable material for the squealer tip extension 34 is a second rhodium-based alloy having rhodium, platinum, and palladium, wherein the alloy is a microstructure that is essentially free of L1₂-structured phase at a temperature greater than about 1000° C. More particularly, the Pd is present in an amount ranging from about 1 atomic percent to about 41 atomic percent; the Pt is present in an amount that is dependent upon the amount of palladium, such that: a) for the amount of palladium ranging from about 1 atomic percent to about 14 atomic percent, the platinum is present up to about an amount defined by the formula (40+X) atomic percent, wherein X is the amount in atomic percent of the palladium; and b) for the amount of palladium ranging from about 15 atomic percent up to about 41 atomic percent, the platinum is present in an amount up to about 54 atomic percent; and the balance comprises rhodium, wherein the rhodium is present in an amount of at least 24 atomic percent.

The first and second preforms 32 and 34 are constructed through a metal injection molding (MIM) process in which a fine metallic powder is mixed with a plastic binder and extruded to a desired shape using plastic molding equipment.

For each preform 32 and 34, the binder and the respective metallic powder are thoroughly mixed together. The mixtures are then heated to melt the binder and create a fluid with the metallic powder coated by the binder. Next, the mixtures are individually formed into predetermined shapes. One way of forming the mixtures is to use a known injection-molding apparatus.

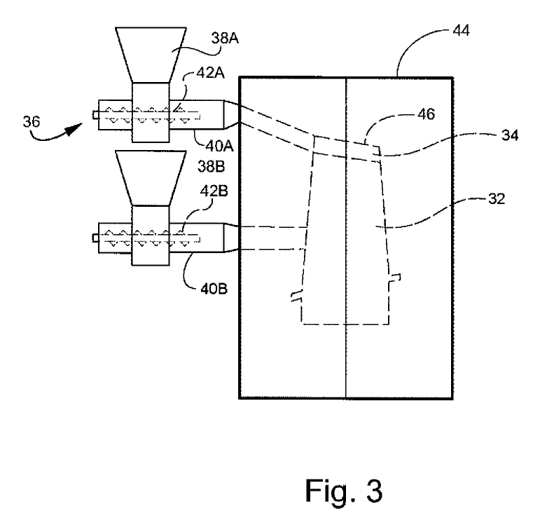

FIG. 3 shows a schematic view of an injection molding apparatus 36 including first and second hoppers 38A and 38B, and first and second extruders 40A and 40B, each having a rotating screw 42A, 42B respectively. The respective mixtures are extruded into portions of the cavity 46 of a mold 44. The mold 44 may optionally be heated to avoid excessively rapid solidification of the binder which would result in a brittle preform. Instead of melting the binder in a discrete batch, the mixture could be molded in a continuous manner using known injection molding equipment capable of melting the binder as it passes through the screws 42A, 42B.

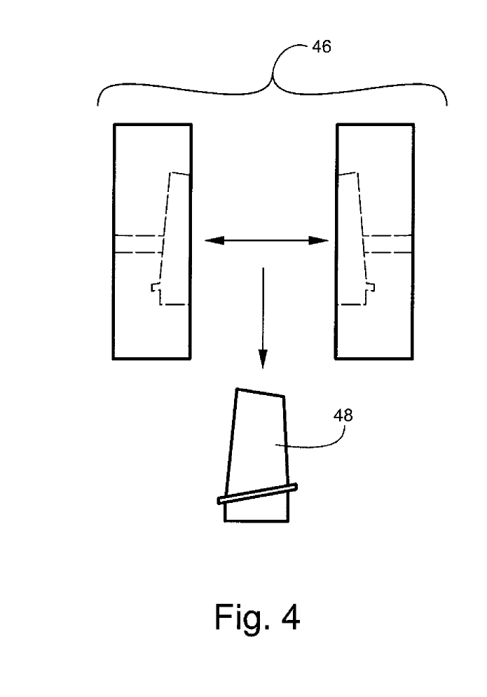

As shown in FIG. 4, once the mixtures have solidified, the mold 44 is opened and the resulting uncompacted or “green” combined preform 48, formed of the individual preforms 32 and 34, is removed.

The combined preform 48 includes metal particles suspended in the solidified binder. The preform 48 is not suitable for use as a finished component, but has sufficient mechanical strength to undergo further processing. The preform 48 is leached to remove the majority of the binder. This may be done by submerging or washing the combined preform 48 with a suitable solvent which dissolves the binder but does not attack the metallic powder.

The combined preform 48 is then sintered by heating the combined preform 48 to a temperature below the liquidus temperature of the metallic powders and high enough to cause the metallic powder particles to fuse together and consolidate, bonding the two individual preforms 32 and 34. The high temperature also melts and drives out any remaining binder.

The preform 48 is held at the desired temperature for a selected time period long enough to result in a consolidated, sintered “brown” preform. When the sintering cycle is complete, the resulting turbine blade 10 (FIG. 1) is allowed to cool. The turbine blade 10 may be subjected to further consolidation using a known hot isostatic pressing (“HIP”) process to ensure that the component is substantially 100% dense.

If desired, the turbine blade 10 may be subjected to additional processes such as final machining, coating, inspection, etc. in a known manner.

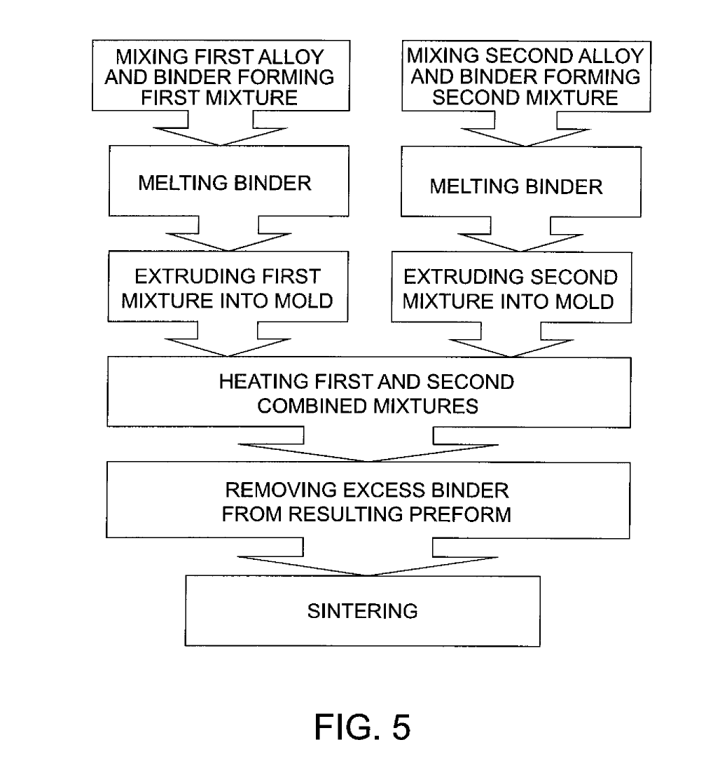

A method according to the application is shown in flow-chart form in FIG. 5. First and second alloys are mixed with a binder to form first and second mixtures. The first and second mixtures are then separately heated to melt the respective binders. In this melted condition the first and second mixtures are separately extruded into a single mold to form a combined mixture, which is then heated. The excess binder is removed from the resulting preform. The preform is then sintered to intimately unite the combined mixtures and form a resulting bimetallic component.

The foregoing has described a manufacturing process for a bimetallic component, and a bimetallic component made according to the disclosed process. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation, the invention being defined by the claims.

What is claimed is:

1. A method of producing a bimetallic component, comprising:
(a) providing a first preform comprising a metallic powder of a first alloy;
(b) providing a second preform comprising a metallic powder of a second alloy different from the first alloy; and
(c) heating the first and second preforms to sinter the metal powders together in a consolidated bimetallic component.

2. The method of claim 1 wherein providing the first preform comprises:
(a) providing a first mixture of the first alloy and a binder;
(b) melting the binder and extruding the first mixture in a mold to form a first preform; and
(c) removing any excess binder.

3. The method of claim 1 wherein providing the second preform comprises:
(a) providing a first mixture of the metallic powder of the second alloy and a binder;
(b) melting the binder and extruding the second mixture in a mold to form a second preform; and
(c) removing any excess binder.

4. The method of claim 2, wherein removing any excess binder comprises washing the preform with a solvent selected to dissolve the binder but not the metallic powder.

5. The method of claim 3, wherein removing any excess binder comprises washing the preform with a solvent selected to dissolve the binder but not the metallic powder.

6. The method of claim 1, wherein providing the second preform comprises:
(a) providing the metallic powder of the second alloy; and
(b) compacting the metallic powder into a mold under pressure to form the second preform.

7. The method of claim 1, wherein providing the first preform and the second preform comprises at least one of the respective first and second metallic powders being a rhodium-based alloy.

8. The method of claim 1 wherein at least one of the metallic powders comprises a nickel-based superalloy.

9. The method of claim 1, wherein producing a bimetallic component comprises producing a stationary turbine vane.

10. The method of claim 1, wherein producing a bimetallic component comprises producing a turbine engine frame.

11. The method of claim 1, wherein producing a bimetallic component comprises producing a combustor.

12. A method of producing an airfoil, comprising:
(a) providing a first preform comprised of a metallic powder of a first alloy, the first preform defining an airfoil body having curved pressure and suction sides, a tip cap disposed between the pressure and suction sides at a radially outer end of the airfoil body and a partial height squealer tip extending radially outwards from the tip cap;
(b) providing a second preform comprising a metallic powder of a second alloy different from the first alloy and formed in the shape of an extension of the squealer tip; and
(c) heating the first and second preforms to sinter the metal powders together in a consolidated airfoil.

13. The method of claim 12, wherein providing the first preform comprises:
(a) providing a mixture of the metallic powder of the first alloy and a binder; melting the binder and extruding the first mixture in a mold to form the first preform; and
(b) removing any excess binder.

14. The method of claim 12, wherein providing the second preform comprises:
(a) providing a mixture of the metallic powder of the second alloy and a binder;
melting the binder and extruding the second mixture in a mold to form the second preform; and
(b) removing any excess binder.

15. The method of claim 13, wherein removing any excess binder comprises washing the first preform with a solvent selected to dissolve the binder but not the metallic powder.

16. The method of claim 13, wherein removing any excess binder comprises washing the second preform with a solvent selected to dissolve the binder but not the metallic powder.

17. A method of producing an airfoil, comprising:
(a) providing a first preform comprising a metallic powder of a first alloy, the first preform defining an airfoil body having curved pressure and suction sides, a tip cap disposed between the pressure and suction sides at a radially outer end of the airfoil body and a partial height squealer tip extending radially outwards from the tip cap;
(b) providing a second preform comprising a metallic powder of a second alloy different from the first alloy and formed in the shape of an extension of the squealer tip; and
(c) sintering the first and second preforms together to form a consolidated airfoil.

18. The method of claim 17, wherein providing the first preform and second preform comprises:
(a) mixing the metallic powder of the first alloy and a binder to form the first mixture, melting the binder and extruding the first mixture into a mold to form the first preform;
(b) leaching any excess binder from the first preform;
(c) mixing the metallic powder of the second alloy and a binder to form the second mixture, melting the binder and extruding the second mixture into the mold to form the second preform; and
(d) leaching any excess binder from the second preform.

19. An airfoil manufactured according to the method set out in claim 17.

20. An airfoil, comprising:
(a) an airfoil body having curved pressure and suction sides, a tip cap disposed between the pressure and suction sides at a radially outer end of the airfoil body and a partial height squealer tip extending radially outwards from the tip cap and formed of a first preform comprising a metallic powder of a first alloy;
(b) an extension of the squealer tip comprised of a metallic powder of a second alloy different from the first alloy; and
(c) the first and second preforms comprising consolidated metal powders.
